(19) United States
(12) Patent Application Publication
(10) Pub. No.: US 2006/0217828 A1
(43) Pub. Date: Sep. 28, 2006

(54) Music searching system and method

(76) Inventor: Wendell T. Hicken, La Verne, CA (US)

Correspondence Address: CHRISTIE, PARKER & HALE, LLP, PO BOX 7068, PASADENA, CA, 91109-7068, US

(21) Appl. No.: 11/369,640

(22) Filed: Mar. 6, 2006

Related U.S. Application Data
(63) Continuation-in-part of application No. 10/917,865, filed on Aug. 13, 2004.
(63) Continuation-in-part of application No. 10/278,636, filed on Oct. 23, 2002.
(60) Provisional application No. 60/658,739, filed on Mar. 4, 2005.

(51) Int. Cl. G06F 17/00

(52) U.S. Cl. 700/94

(57) ABSTRACT

A music searching system and method conducting a metadata search of music based on an entered search term. Music identified from the metadata search is used as seed music to identify other acoustically complementing music. Acoustic analysis data of the seed music is compared against acoustic analysis data of potential candidates for determining whether they are acoustically complementing music. The acoustically complementing music is then displayed to the user for listening, downloading, or purchase.

### CROSS-REFERENCE TO RELATED APPLICATION(S)

This application claims the benefit of U.S. Provisional Application No. 60/658,739, filed on Mar. 4, 2005, and is a continuation-in-part of U.S. application Ser. No. 10/917,865, filed on Aug. 13, 2004 (attorney docket 52075), a continuation-in-part of U.S. application Ser. No. 10/668,926, filed on Sep. 23, 2003 (attorney docket 50659), a continuation-in-part of Ser. No. 10/278,636, filed on Oct. 23, 2002 (attorney docket 48763), and a continuation-in-part of U.S. application Ser. No. 11/236,274, filed on Sep. 26, 2005 (attorney docket 56161), which in turn is a continuation of U.S. application Ser. No. 09/556,051, now abandoned, filed on Apr. 21, 2000 (attorney docket 37273), the content of all of which are incorporated herein by reference.

### FIELD OF THE INVENTION

This invention relates generally to a computer system for searching for music, and more particularly, to a computer system that provides acoustically complementing music based on seed music discovered via a metadata search of a key term.

### BACKGROUND OF THE INVENTION

Today's music scene provides a user with hundreds and thousands of different types of music that may be available for his or her enjoyment. The vast selection arena creates a dilemma for the user when faced with a decision as to which particular piece of music or album to listen or purchase.

U.S. application Ser. No. 10/917,865 describes a music recommendation system where a user may generate a playlist or search for music, using a song, album, or artist that is owned by the user as a search seed. It would be desirable, however, not to limit the search seed to music that is owned by the user. That is, although the user may not own a copy of a particular piece of music, he or she may nonetheless be familiar with the music, and may want to generate a playlist or search for songs, albums, or artists, using this piece of music as the search seed.

Web services exist that allow a user to enter a key term for a particular song, album, or artist, and the web service retrieves songs, albums, or artists, that contain the key term. In doing so, such web services look at the metadata attached to each song, album, or artist, and determines if the metadata contains the desired key term. However, although the retrieved music may all share the same key term, they may not all be to the user's liking, and may not acoustically complement each other.

Accordingly, what is desired is a system and method that allows the user to generate playlists, conduct searches, and the like, using music that may not necessarily be owned by the user as the search seed for retrieving other music that acoustically complements the search seed.

### SUMMARY OF THE INVENTION

The present invention is directed to an audio searching server and method. The server receives a search key, performs a metadata search based on the search key, identifies a first audio piece or group responsive to the metadata search, and automatically invokes a complementing music search based on the identified first audio piece or group. The complementing music search includes retrieving acoustic analysis data for the identified audio piece or group, identifying a second audio piece, album, or artist that, based on the retrieved acoustic analysis data, is determined to acoustically complement the first audio piece or group, and displaying information on the identified second audio piece, album or artist. The second audio piece may then be used to generate a digital content program, such as, for example, a playlist. The second audio piece may also be delivered to an end device.

According to one embodiment of the invention, the audio group is a particular artist or album.

According to one embodiment of the invention, the search key includes alphanumeric characters, and the identifying the first audio piece or group includes searching metadata associated with the first audio piece or group for the alphanumeric characters.

According to one embodiment of the invention, the search key is an audio fingerprint, and the identifying the first audio piece or group includes searching metadata associated with the first audio piece or group for the audio fingerprint.

According to one embodiment of the invention, the second audio piece, album, or artist has associated metadata that does not contain the search key.

According to one embodiment of the invention, the acoustic analysis data provides numerical measurements for a plurality of predetermined acoustic attributes based on an automatic processing of audio signals of the first audio piece.

According to another embodiment, the present invention is directed to an audio searching method that includes receiving a search key for a first audio piece or group, and recommending a plurality of audio pieces or groups that acoustically complement the first audio piece or group, where at least a portion of the recommended audio pieces or groups have associated metadata that does not contain the search key.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a music searching system according to one embodiment of the invention;

FIG. 2 is a flow diagram of a music searching process according to one embodiment of the invention;

FIG. 3 is a screen shot of a user interface provided by a first server according to one embodiment of the invention;

FIG. 4 is a screen shot displaying a list of artists satisfying a metadata search for an artist search term according to one embodiment of the invention;

FIG. 5 is a screen shot displaying a list of acoustically related albums for each artist satisfying an artist metadata search according to one embodiment of the invention;

FIG. 6 is a screen shot displaying a list of albums satisfying a metadata search for an album search term according to one embodiment of the invention;

FIG. 7 is a screen shot displaying a list acoustically related albums for each album satisfying an album metadata search according to one embodiment of the invention;

FIG. 8 is a screen shot displaying a list of songs satisfying a metadata search for a song search term according to one embodiment of the invention; and

FIG. 9 is a screen shot of a display of a list acoustically related songs for each song satisfying a song metadata search according to one embodiment of the invention.

### DETAILED DESCRIPTION

In general terms, the present invention is directed to a web service which allows a user to enter a search key for a particular song, album, or artist (collectively referred to as music), and the web service retrieves other music that acoustically complements seed music identified via the search key. Unlike a traditional search that simply looks at metadata attached to the music and retrieves that music if it contains the search key, the complementing music that is retrieved according to the embodiments of the present invention often does not contain the search key in its metadata. Nonetheless, such music is retrieved based on its acoustic description, more specifically, how that acoustic description relates to the acoustic description of the seed music.

Hereinafter, seed music refers to music that is retrieved based on search of its metadata for a particular search key. According to one embodiment of the invention, the search key is composed of alphanumeric characters. However, a person of skill in the art should recognize that the search key may take other forms, such as, for example, images, audio clips, audio fingerprints, and the like.

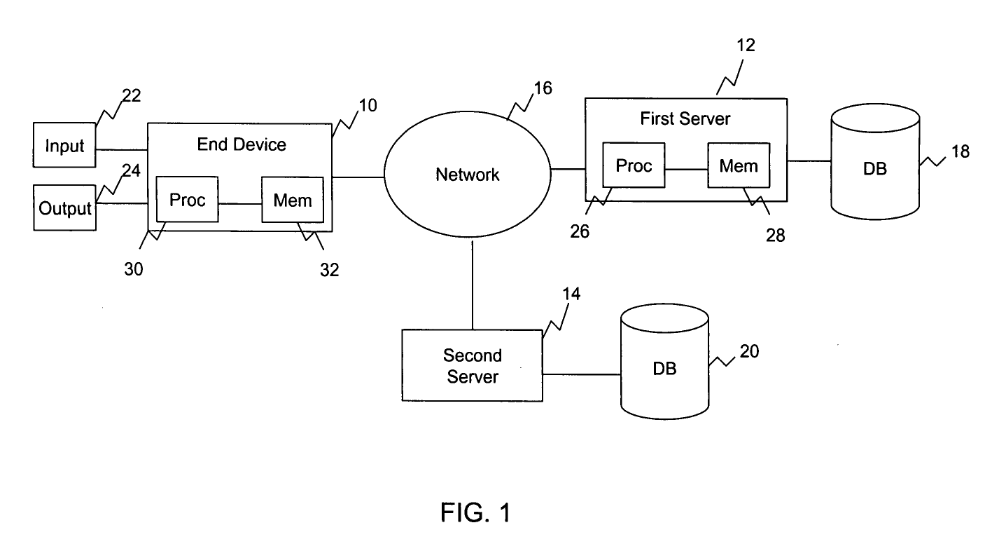

FIG. 1 is a block diagram of a music searching system according to one embodiment of the invention. The music searching system includes an end device 10, a first server 12, and a second server 14, coupled to each other over a data communications network 16. The network may be any data communications network conventional in the art, such as, for example, a local area network, a wide area network, the Internet, a cellular network, or the like. Any wired or wireless technologies known in the art may be used to implement the data communications network.

The end device 10 includes a processor 30 and memory 32, and is coupled to an input device 22 and an output device 24. The end device 10 may be a personal computer, personal digital assistant (PDA), entertainment manager, car player, home player, portable player, portable phone, or any consumer electronics device known in the art.

The first and second servers 12, 14 may be, for example, web servers providing music related products and/or services to the end device 10, to each other, or to other servers coupled to the data communications network 16. For example, the first server 12 may provide music searching services to allow a user to discover artists, albums, and songs that complement the sounds of music that the user knows and likes. The second server 14 may be a retailer server to which the user may be directed for purchasing, downloading, and/or listening the discovered songs and/or albums.

The first and second servers 12, 14 are respectively coupled to first and second data stores 18, 20 taking the form of hard disk drives, drive arrays, or the like. According to one embodiment of the invention, either the first data store 18, the second data store 20, or both, store all or a portion of a metadata database, an acoustic analysis database, and/or a group profile database. The first and/or second data stores 18, 20 may further store copies of the songs or CDs, and include other information, such as, for example, fingerprint information for uniquely identifying the songs.

The metadata database stores metadata information for various songs, albums, and the like. The metadata information may include, for example, a song title, an artist name, an album name, a track number, a genre name, a file type, a song duration, a universal product code (UPC) number, a rating, or the like. The metadata database may also store fingerprint data for the various songs. A more detailed explanation of the fingerprint generation is provided in the above-referenced U.S. application Ser. No. 10/668,926.

The acoustic analysis database stores acoustic analysis data for the various songs. The acoustic analysis data for a particular song (also referred to as its acoustic description) may be generated by the first and/or second server 12, 14, or by a third party device (collectively referred to as the generating device) which then uploads the acoustic analysis data to the first and/or second server 12, 14. In generating the acoustic analysis data, the generating device engages in automatic analysis of the audio signals of the song to be analyzed via an audio content analysis module. The audio content analysis module takes the audio signals and determines its acoustic properties/attributes, such as, for example, tempo, repeating sections in the audio piece, energy level, presence of particular instruments (e.g. snares and kick drums), rhythm, bass patterns, harmony, particular music classes (e.g. jazz piano trio), and the like. The audio content analysis module computes objective values of these acoustic properties as described in more detail in U.S. patent application Ser. Nos. 10/278,636 and 10/668,926, the content of which are incorporated herein by reference. As the value of each acoustic property is computed, it is stored into an acoustic attribute vector as the audio description or acoustic analysis data for the audio piece. The acoustic attribute vector thus maps calculated values to their corresponding acoustic attributes.

The group profile database stores profile data for a group of audio pieces, such as the audio pieces in a playlist, in an album, or associated with a particular artist. The profile data may be represented as a group profile vector storing coefficient values for each of the attributes in an acoustic attribute vector. According to one embodiment of the invention, a group profile vector is generated based on analysis of the individual acoustic attribute vectors of the songs belonging to the group, as is described in further detail in U.S. application Ser. Nos. 10/278,636 and 10/917,865. The coefficient values in a group profile vector help determine the most distinct and unique attributes of a set of songs with respect to a larger group.

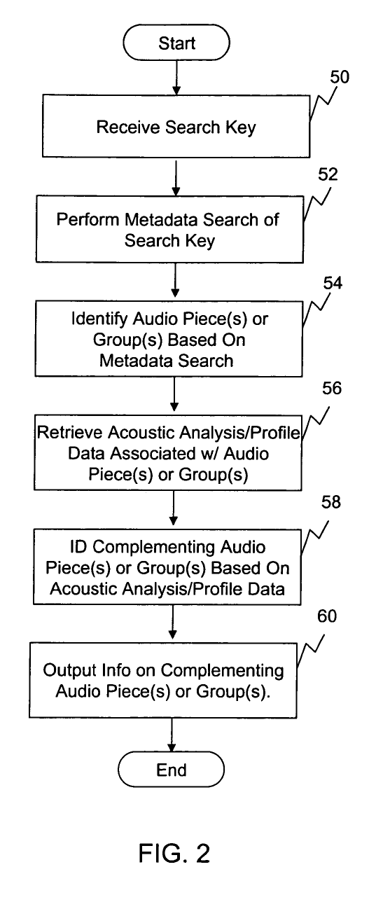

FIG. 2 is a flow diagram of a music searching process according to one embodiment of the invention. The process may be a software process run by a processor 26 included in the first server 12 according to computer program instructions stored in its internal memory 28.

In step 50, the processor 26 receives a search key from a user of the end device 10 over the data communications network 16. The search key is accompanied with a request to find complementing music. According to one embodiment, the search key includes all or a portion of the name of an artist, album, or song, to be used as seed music. The search key may also take the form of an audio fingerprint of the seed music, and/or provide other metadata information such as, for example, genre information, for identifying the seed music.

In order to allow the user to request the search, the first server provides a web page that is retrieved by the end device 10 and displayed on the output device 24. The end device 10 is equipped with browser software or other like software application to allow the processor 30 at the end device to retrieve and display the web page.

In step 52, the processor 26 performs a metadata search of the search key. According to one embodiment of the invention, the metadata search solely looks at the metadata information that is attached (or associated) with a song, album, or artist. In this regard, the processor 26 invokes a search and retrieval algorithm that searches the metadata database in the first data store 18 for the search key. Otherwise, if the metadata database is stored in the second data store 20, the processor 26 may simply forward the search key to the second server 14 for causing the latter to conduct the search and provide the search results to the first server.

In step 54, the processor identifies one or more audio pieces (e.g. songs) or groups (e.g. an album or an artist) based on the metadata search. Following the metadata search, the processor automatically engages in a complementing music search based on the audio pieces or groups identified from the metadata search. In implementing the complementing music search, the identified audio pieces or groups are used as seed music for retrieving other audio pieces or groups that acoustically complement the seed music. In this regard, the processor 26, in step 56, retrieves acoustic analysis and/or profile data for each audio piece and/or group identified from the metadata search. The acoustic analysis data may be an acoustic attribute vector associated with the audio piece. The profile data may be a group profile vector associated with the identified audio group.

In step 58, the processor identifies another audio piece or group based on each retrieved acoustic analysis and/or profile data. In identifying a complementing audio piece or group, the processor 26 conducts a vector comparison between the acoustic analysis and/or profile data associated with the seed music and acoustic analysis and/or profile data associated with a potentially complementing audio piece and/or group. Details of such vector comparisons is described in further detail in the above-identified U.S. application Ser. Nos. 10/278,636 and 10/917,865. If the potentially complementing audio piece or group is deemed to be within a certain vector distance of the seed music, information on the audio piece or group is output to the user in step 60. For example, the user may be provided with a link to the second server 14 for allowing the user to listen, download, and/or purchase the complementing audio piece or group. Alternatively, a digital content program (e.g. a playlist) may be generated based on the complementing audio piece or group. The digital content program may then be streamed to the user for listening by the user.

It should be appreciated that the complementing audio piece or group may not contain the search key initially entered by the user in its metadata. The complementing audio piece or group is nonetheless selected based on the acoustic similarity with the seed music.

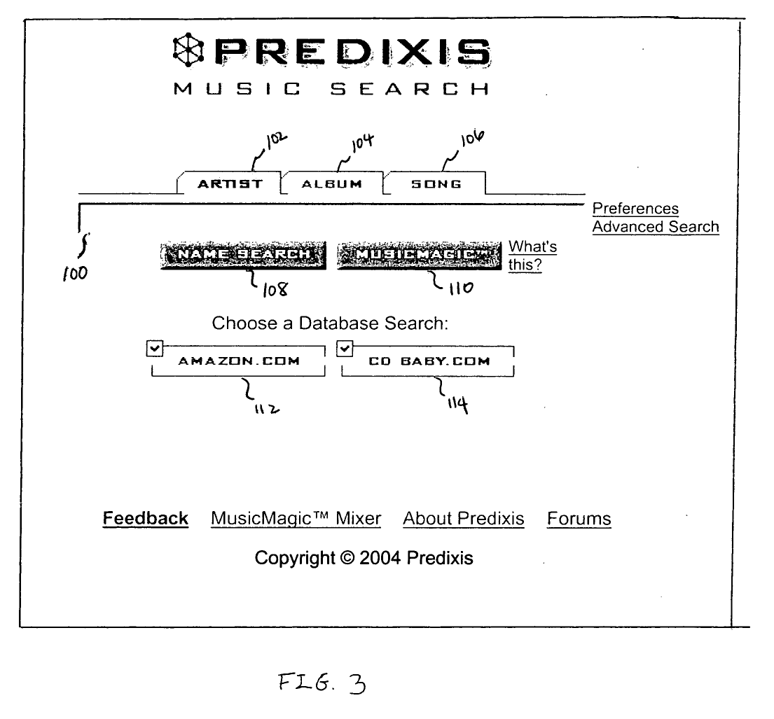

FIG. 3 is a screen shot of a user interface provided by the first server 12 according to one embodiment of the invention. The user interface provides an artist tab 102, an album tab 104, and a songs tab 106, which, when selected, respectively allow the user to conduct a search for artists, albums, and songs.

A search input area 100 allows the user to enter a search key for conducting the search. The search seed may include, for example, all or a portion of an artist's name, album's name, song's name, and/or fingerprint data. After entry of the search seed, the user may request a simple metadata search, or a complementing music search. Selection of a metadata search button 108 starts a metadata search of artists, albums, or songs, satisfying the entered search term. The user may set, via manipulation of buttons 112, 114, the particular metadata databases that are to be included in the metadata search. Such metadata databases may be identified, for example, by the name of the retailer associated with the database.

If, however, the user wants to invoke a complementing music search, the user enters a metadata search key and selects a complementing music button 110. Selection of the complementing music button first invokes a metadata search based on the search key for an artist, album, or song which metadata includes the search key. Then, for each identified artist, album, or song (seed music), a complementing music search is then automatically invoked for searching for one or more other acoustically complementing artists, albums, or songs. Information on such acoustically complementing audio pieces or groups is displayed relative to the seed music.

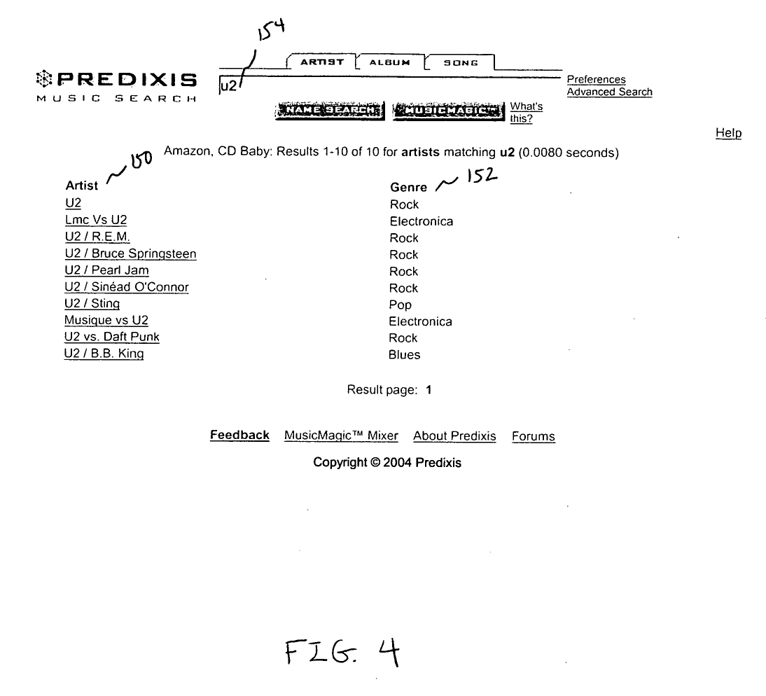

FIG. 4 is a screen shot displaying a list of artists satisfying a metadata search for an artist search term 154 upon selection of the metadata search button 112 according to one embodiment of the invention. Information on the one or more artists satisfying the search query includes, for example, the artist's name 150 and associated genre information 152. According to one embodiment, selection of a displayed artist's name 150 causes display of all albums associated with the artist.

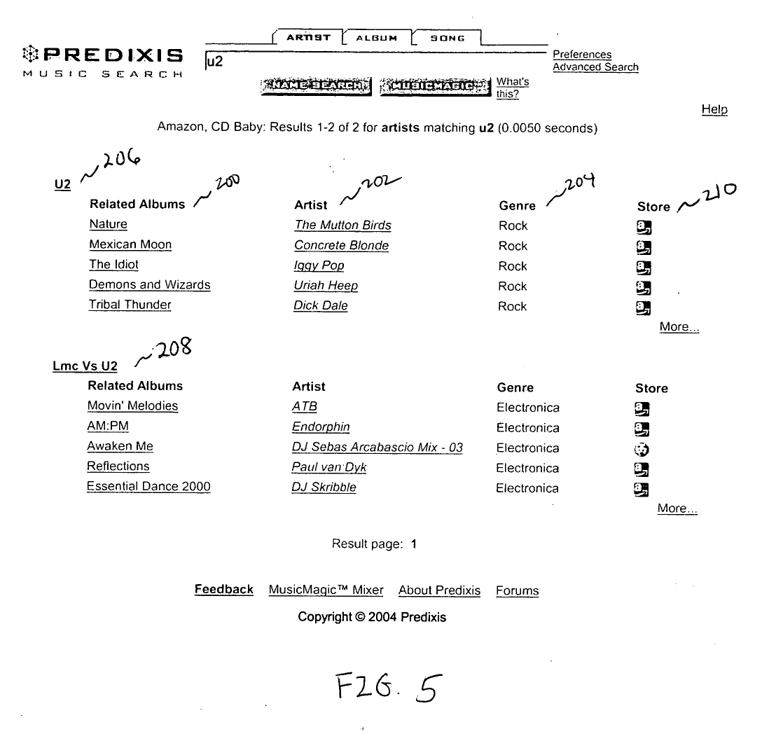

FIG. 5 is a screen shot displaying search results upon a request for music complementing an artist according to one embodiment of the invention. The user enters a search key into the search input area 100 and selects the complementing music button 114 to invoke the complementing music search. In response, the web page displays a list of artists 206, 208 satisfying a metadata search of the key term. In addition, below each artist is a list of acoustically complementing albums 200 for the corresponding seed artist. The complementing album 200 may be selected based on a comparison of a group profile vector for the seed artist and a group profile vector for the complementing album as is described in further detail in the above-referenced U.S. application Ser. No. 10/278,636.

According to one embodiment of the invention, also displayed for each acoustically complementing album is an artist name 202 and genre 204 information. Alternatively, the web page may display below each seed artist a list of acoustically complementing artists instead of acoustically complementing albums.

According to one embodiment of the invention, a store link 210 is also provided for each complementing album which allows the end device 10 to be redirected to a retailer server, such as, for example, the second server 14, to allow the user to listen, download, and/or purchase the complementing album, upon selection of the link.

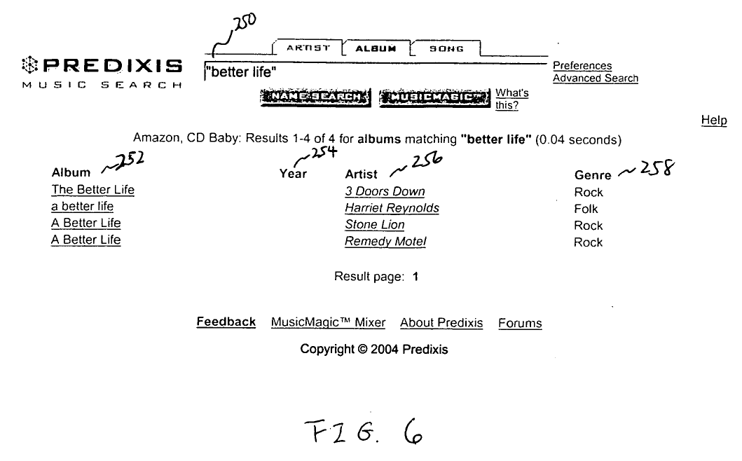

FIG. 6 is a screen shot displaying a list of albums satisfying a metadata search for an album search term 250 upon selection of the metadata search button 112 according to one embodiment of the invention. Information on the one or more albums satisfying the search query includes, for example, the album name 252, release year 254, artist name 256, and associated genre 258. According to one embodiment, selection of a displayed album name 252 causes display of all tracks in the selected album. Selection of a displayed artist name 256 causes display of all albums associated with the artist.

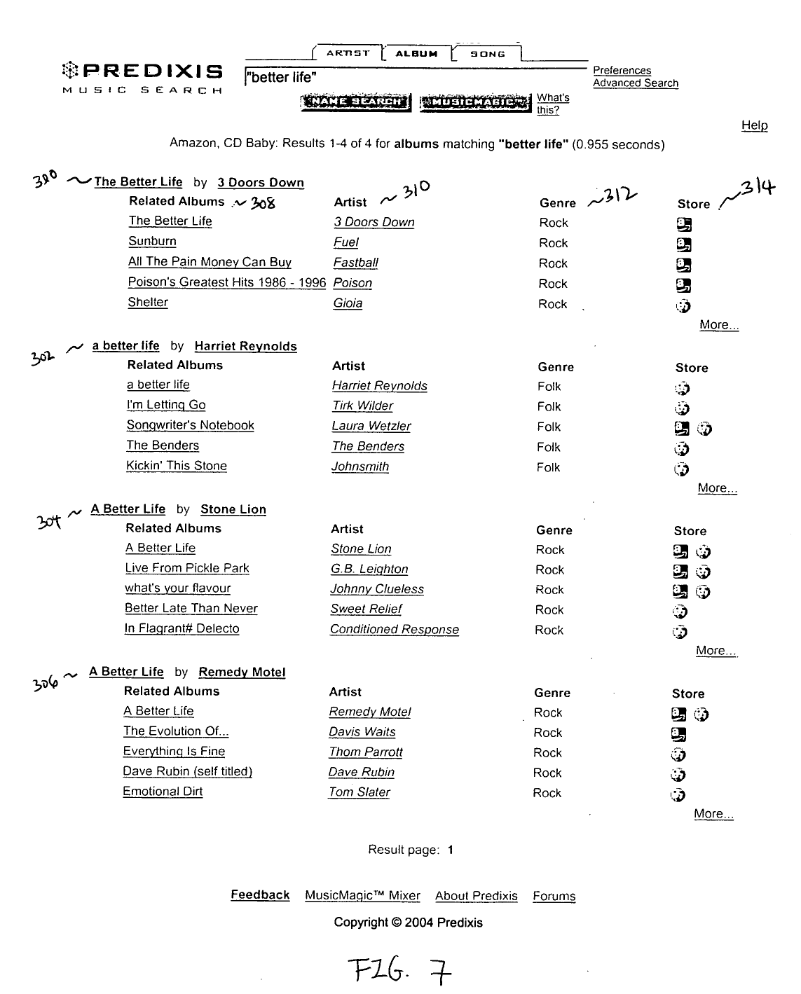

FIG. 7 is a screen shot displaying search results upon a request for music complementing an album according to one embodiment of the invention. The user enters a search key into the search input area 100 and selects the complementing music button to invoke the complementing music search. In response, the web page displays a list of albums 300-306 satisfying a metadata search of the key term. In addition, below each album is a list of acoustically complementing albums 308 for the corresponding seed album. The complementing album 200 may be selected based on a comparison of a group profile vector for the seed album and a group profile vector for the complementing album as is described in further detail in the above-referenced U.S. application Ser. No. 10/278,636.

According to one embodiment of the invention, also displayed for each acoustically complementing album is an artist name 310 and genre 312 information. According to one embodiment of the invention, a store link 314 is also provided for each complementing album which allows the end device 10 to be redirected to a retailer server, such as, for example, the second server 14, to allow the user to listen, download, and/or purchase the complementing album, upon selection of the link.

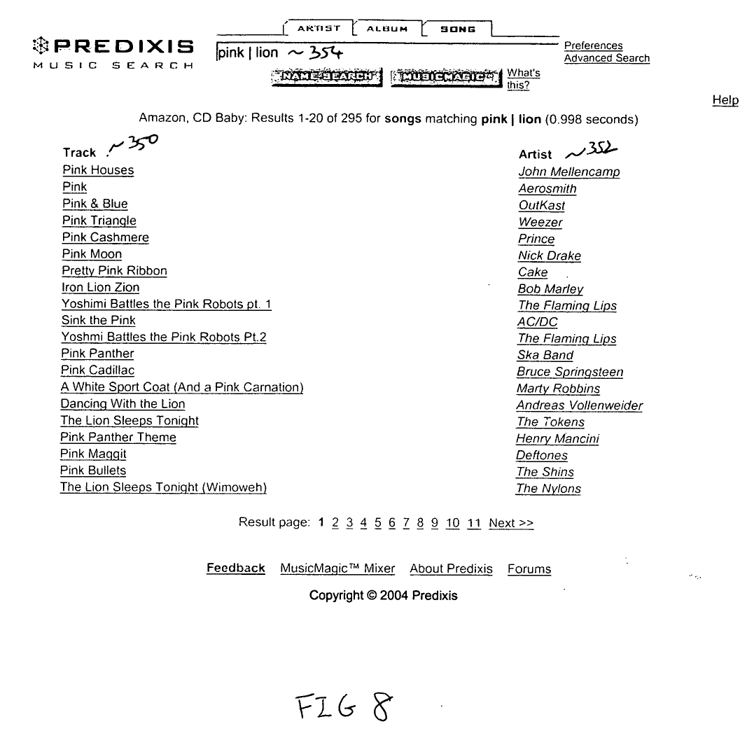

FIG. 8 is a screen shot displaying a list of songs satisfying a metadata search for a song search term 354 upon selection of the metadata search button 112 according to one embodiment of the invention. Information on the one or more songs satisfying the search query includes, for example, the song name 350 and an artist name 352. According to one embodiment, selection of a displayed artist name causes display of all albums associated with the artist.

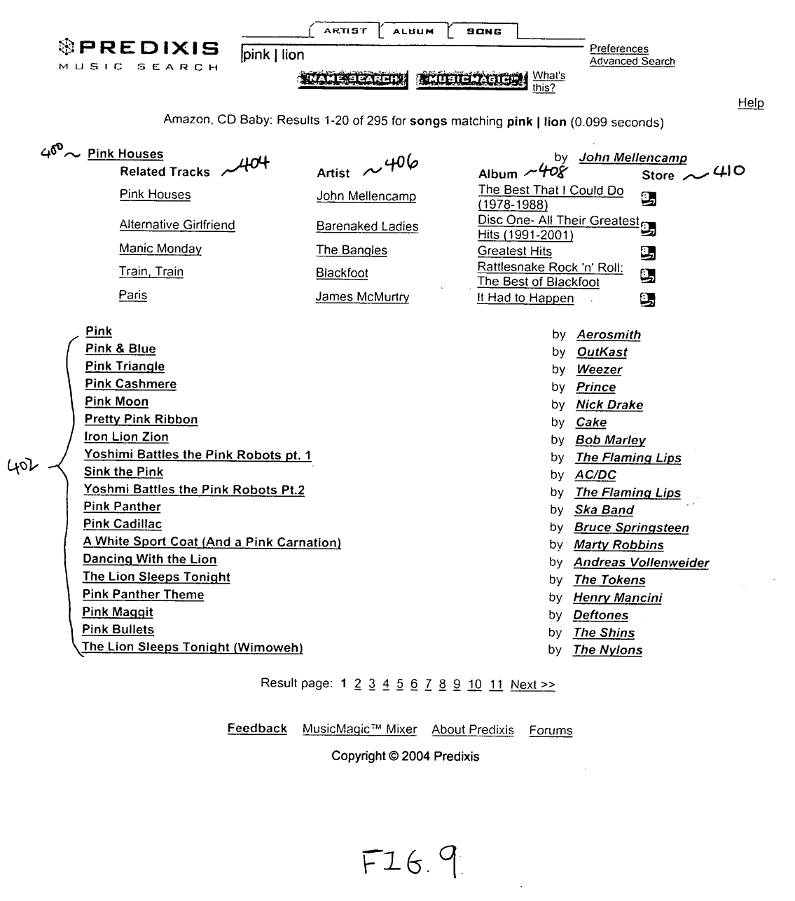

FIG. 9 is a screen shot displaying search results upon a request for music complementing a song according to one embodiment of the invention. The user enters a search key into the search input area 100 and selects the complementing music button 114 to invoke the complementing music search. In response, the web page displays a list of songs 400, 402 satisfying a metadata search of the key term. In addition, below each song is a list of acoustically complementing songs 404 for the corresponding seed song. The complementing song 404 may be selected based on a comparison of an acoustic attribute vector for the seed song and an acoustic attribute vector for the complementing song as is described in further detail in the above-referenced U.S. application Ser. No. 10/278,636.

According to one embodiment of the invention, also displayed for each acoustically complementing song is an artist name 406 and album name 408. According to one embodiment of the invention, a store link 410 is also provided for each complementing song which allows the end device 10 to be redirected to a retailer server, such as, for example, the second server 14, to allow the user to listen, download, and/or purchase the complementing song or related album, upon selection of the link.

Although this invention has been described in certain specific embodiments, those skilled in the art will have no difficulty devising variations which in no way depart from the scope and spirit of the present invention. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

What is claimed is:

1. An audio searching method comprising:
receiving a search key;
performing a metadata search based on the search key;
identifying a first audio piece or group responsive to the metadata search; and
automatically invoking a complementing music search based on the identified first audio piece or group, the complementing music search including:
retrieving acoustic analysis data for the identified audio piece or group;
identifying a second audio piece, album, or artist that, based on the retrieved acoustic analysis data, is determined to acoustically complement the first audio piece or group; and
displaying information on the identified second audio piece, album or artist.

2. The method of claim 1, wherein the audio group is a particular artist or album.

3. The method of claim 1 further comprising generating a digital content program including the second audio piece.

4. The method of claim 1 further comprising delivering the second audio piece to an end device.

5. The method of claim 1, wherein the search key includes alphanumeric characters, and the identifying the first audio piece or group includes searching metadata associated with the first audio piece or group for the alphanumeric characters.

6. The method of claim 1, wherein the search key is an audio fingerprint, and the identifying the first audio piece or group includes searching metadata associated with the first audio piece or group for the audio fingerprint.

7. The method of claim 1, wherein the second audio piece, album, or artist has associated metadata that does not contain the search key.

8. The method of claim 1, wherein the acoustic analysis data provides numerical measurements for a plurality of predetermined acoustic attributes based on an automatic processing of audio signals of the first audio piece.

9. An audio searching method comprising:
receiving a search key for a first audio piece or group; and
recommending a plurality of audio pieces or groups that acoustically complement the first audio piece or group, wherein at least a portion of the recommended audio pieces or groups have associated metadata that does not contain the search key.

10. An audio searching server comprising:
a processor; and
a memory operably coupled to the processor and storing program instructions therein, the processor being operable to execute the program instructions, the program instructions including:
receiving a search key;
performing a metadata search based on the search key;
identifying a first audio piece or group responsive to the metadata search; and
automatically invoking a complementing music search based on the identified first audio piece or group, the complementing music search including:
retrieving acoustic analysis data for the identified audio piece or group;
identifying a second audio piece, album, or artist that, based on the retrieved acoustic analysis data, is determined to acoustically complement the first audio piece or group; and
displaying information on the identified second audio piece, album or artist.

11. The server of claim 10, wherein the audio group is a particular artist or album.

12. The server of claim 10 further comprising generating a digital content program including the second audio piece.

13. The server of claim 10 further comprising delivering the second audio piece to an end device.

14. The server of claim 10, wherein the search key includes alphanumeric characters, and the identifying the first audio piece or group includes searching metadata associated with the first audio piece or group for the alphanumeric characters.

15. The server of claim 10, wherein the search key is an audio fingerprint, and the identifying the first audio piece or group includes searching metadata associated with the first audio piece or group for the audio fingerprint.

16. The server of claim 10, wherein the second audio piece, album, or artist has associated metadata that does not contain the search key.

17. The server of claim 10, wherein the acoustic analysis data provides numerical measurements for a plurality of predetermined acoustic attributes based on an automatic processing of audio signals of the first audio piece.
